(19) United States
(12) Patent Application Publication
(10) Pub. No.: US 2010/0084161 A1
(43) Pub. Date: Apr. 8, 2010

(54) CONDUCTIVE FILM AND PROCESS FOR MAKING SAME

(75) Inventors: Robert A. Neal, Wales, ME (US); Robert B. Ray, Manchester, ME (US); Thomas J. Dougherty, Waukesha, WI (US)

Correspondence Address: CHRIS A. CASEIRO, VERRILL DANA, LLP, ONE PORTLAND SQUARE, PORTLAND, ME, 04112-0586, US

(73) Assignees: Robert A. Neal, Wales, ME (US); Robert B. Ray, Manchester, ME (US)

(21) Appl. No.: 12/574,389

(22) Filed: Oct. 6, 2009

Related U.S. Application Data
(60) Provisional application No. 61/103,788, filed on Oct. 8, 2008.

(51) Int. Cl. H01B 5/00; B29C 49/00; B29C 39/00

(52) U.S. Cl. 174/126.1; 264/544; 264/299; 264/210.1

(57) ABSTRACT

A conductive polyolefin film characterized by acceptable physicals, no pinholes, and a resistance through its thickness of less than about 100 ohms, preferably less than about 10 ohms, and a method for making the same. The film includes a structural polymeric material such as a polyolefin blended with conductive additives such as carbon filler to produce desired characteristics. The film may be surface treated to enhance its ability to bond to other materials. The process includes combining and blending a plurality of resins with different conductive carbon loaded polymers, drying the conductive resin mix to a selected moisture content, converting the conductive film resin into a fluidized solid, and forming a film. The film and method of the present invention provide films suitable for use in a range of applications, including as conductive media for electrodes in batteries and capacitors or in desalination/deionization systems. The film has an inherent property of Positive Temperature Coefficient Resistance that may be selected by selecting the ratio of structural material and conductive material, wherein the film increases in resistance at selectable voltages and limits current at a particular point, protecting batteries from short circuit, for example.

### CROSS REFERENCE TO RELATED APPLICATION

The present application claims the priority benefit of U.S. provisional patent application Ser. No. 61/103,788, filed on Oct. 8, 2008, entitled “CONDUCTIVE FILM AND PROCESS FOR MAKING SAME.” The entire contents of that prior application are incorporated herein by reference.

### BACKGROUND OF THE INVENTION

1. Field of the Invention

The present invention relates to polymer-based films and improved film surface characteristics thereof. More particularly, the present invention relates to relatively thin polymer-based films that have conductive characteristics. The conductive polymer-based films possess sufficient conductivity and certain film surface characteristics such that they may be used as a component for electrodes used in batteries or capacitors. The invention includes the process for making such films.

2. Description of the Prior Art

Resins suitable for blown and cast polymer film manufacture and loaded with conductive carbon particles have been available for many years. Commercially available resins suitable for film making and including carbon loading, such as in the form of carbon powder, have been limited to the inclusion of 25% by weight or less of carbon. The typical volume resistance values of films in the thickness range of about 2-25 mils made using such resins are greater than 100 ohms and are not suitable as components for electrodes used in batteries or capacitors. Resin compounders have increased the conductive carbon loading to 50%, which works well for injection molding of polymeric products but are too thick and weigh too much to be a commercially reasonable option as a component in an electrode in a battery or a capacitor. This filled resin makes the extrusion of a film with desirable physical characteristics very difficult. For purposes of the description of this invention, the resistance of a film means the resistance measured in ohms through the thickness of the film for a specified film thickness or film thickness range, which is sometimes referred to as volume resistance, and not the resistance across the surface of the film, which is sometimes referred to as surface resistance.

Conductive carbon nanotubes have also been used with polymer resins to produce polymer-based products of sufficiently thin dimensions with resistance values of less than 100 ohms. Unfortunately, carbon nanotubes are difficult to disperse uniformly throughout the resin such that any resultant film, to the extent it can be manufactured at a uniform desired thickness, will have non-uniform characteristics, including non-uniformity of resistance of the film product, and may have non-uniform resistances through the film thickness. While they may provide suitable resistance characteristics in a polymer film, they reduce the overall structural characteristics of the film. Further, they are relatively costly and therefore make conductive films which are more costly than is desired.

As noted above, resins exist with as much as 50% by weight of carbon loading. However, attempts by the present inventors to produce a polymeric film with a fully 50% conductive carbon loaded polymer resin on a blown film extruder and a cast film extruder met with unsuitable results. In that effort, blends of low density polyethylene, high density polyethylene and polypropylene were used. The blown film attempt failed due to the existence of numerous pinholes that caused the resin bubble to burst prior to desired expansion. The cast film met with some success in that a film sheet was made; however, attempts to reach desired relatively thin film thicknesses were unsuccessful in that numerous pinholes were created and film tearing occurred.

It was determined that in the course of attempting to make a polymer-based conductive film with resistance values of less than 100 ohms that the resin required extensive drying as carbon-loaded resins are very hydroscopic. Any absorbed moisture in the resin will cause outgassing in the heated extrusion process. This causes gels and imperfections throughout the film to be formed, resulting in pinholes in the final film product. Typical drying times for a 25% carbon loaded resin is 6 hours at 150° F. in a desiccant carousel dryer. The 50% carbon loaded resin requires longer drying time. For example, a 50% carbon-filled resin required 12 hours of drying at 150° F. before reaching a satisfactory moisture content. It was also determined in the course of attempting to make the polymer-based conductive film with a resistance less than 100 ohms that the resin loaded with 50% by weight of conductive carbon did not have acceptable puncture and tear strength. The larger loading of conductive carbon produce areas of conductive carbon clusters that produce pinholes in the extruded film. Based on that effort, it was determined that a polymeric film with a resistance below 100 ohms, desired thickness and sufficient structural integrity has not been made available prior to the development of the present invention. It was also determined that it would be desirable to provide a thin polymer film with physical integrity and a resistance through its thickness of less than 100 ohms and preferably below 10 ohms. Such a film could be used in a range of applications, including, but not limited to, batteries and capacitors.

### SUMMARY OF THE INVENTION

It is an object of the present invention to provide a thin polymer film with physical integrity and a resistance of less than 100 ohms, and preferably below 10 ohms, through its thickness. It is also an object of the present invention to provide a process for making such a conductive film. The film includes a structural material, such as a polymer. The polymer may be a polyolefin, such as polyethylene, polypropylene, or blends thereof. The polyethylene may be a high density polyethylene or a low density polyethylene. The structural material is blended with one or more additives to produce desired characteristics. One additive of the film of the present invention is a conductive additive, such as a carbon filler. The carbon filler may be a carbon powder, for example. The structural material and the one or more additives are combined together to produce a resin, such as in pellet form, that may be extruded and processed into the conductive film, or blown and processed into the conductive film.

In one embodiment, the conductive film of the present invention is a conductive carbon filled polyolefin blend that is flexible and sealable, less than about 6 mils thick and with a resistance of less than about 50 ohms. In a second embodiment, the conductive film is a conductive carbon filled polyolefin blend that is flexible and sealable, about 2 mils thick and with a resistance of less than about 10 ohms. This second embodiment of the film may be inert, with minimum oxidation to material. It further provides little to no danger of overcharge of electrons. In a third embodiment, the conductive film is a conductive carbon filled polymer blend that is flexible and sealable, less than about 6 mils thick, with a resistance of less than about 10 ohms and selectively coated with vapor deposition of metals, semiconductors and/or dielectrics so that the film can be sealed where the materials are not deposited. In a fourth embodiment, the conductive film is a conductive carbon filled polyolefin blend that is flexible and sealable, less than about 2 mils thick, with a resistance of less than about 10 ohms, selectively coated with vapor deposition of metals, semiconductors and/or dielectrics so that the film can be sealed where the materials are not deposited. As noted, one or more of the indicated film embodiments may include a metal, such as aluminum, copper or tin, applied to one or both sides thereof. The metal may be applied to the film such as by vacuum metallization. One or more of the indicated film embodiments may include a non-metallic material applied to one or both sides thereof. The non-metallic material may be chemically or mechanically joined to the conductive film, either permanently or removably.

One or more of the one or more embodiments of the conductive film of the present invention may be used as an electrical current collector and pathway for electrons to flow through. Such conductive film may be used as an electrical current collector and pathway for electrons to flow to other connected films, whether conductive or non-conductive. The film may be used for unidirectional electron flow or bidirectional electron flow. The conductive film of the present invention may be used as an anode or a cathode in the construction of batteries or capacitors. It may be used as a bipolar electrode for a capacitor. The film may be used as a laminate to an anode material and/or a cathode material. The film may be laminated to the anode and/or cathode material by a heat lamination process or through the use of a conductive binder. The conductive film may be used as a barrier to block electrolyte transfers. The conductive film may be used as a replacement for any battery metallized electrode conductor whether used with acidic, basic or organic electrolyte solutions. The conductive film in any of the variations described herein including the polymeric structural material can be heat sealed to another non-conductive polymer.

The present invention includes a process of combining and blending a plurality of resins with different conductive carbon loading to produce a thin film with acceptable physicals, no pinholes and a resistance through its thickness of less than about 10 ohms. The resins may include the same or different structural materials. An embodiment of the process of combining and blending includes the process of combining and blending low density polyethylene, high density polyethylene or polypropylene with about 50% conductive carbon loading with a low density polyethylene, high density polyethylene or polypropylene with about a 25% conductive carbon loading to produce a thin conductive film with acceptable physical characteristics, no pinholes and a resistance of less than about 10 ohms.

Another embodiment of the process of combining and blending includes the process of combining and blending about a 40% blend of about 50% loaded conductive carbon polymer with about a 60% blend of about 25% loaded conductive carbon polymer to form a thin conductive film with acceptable physicals, no pinholes and a resistance of about 30 ohms. Another embodiment of the process of combining and blending includes the process of combining and blending about a 50% blend of about 50% loaded conductive carbon polymer with about a 50% blend of about 25% loaded conductive carbon polymer to form a thin conductive film with acceptable physicals, no pinholes and a resistance of less than about 15 ohms. Another embodiment of the process of combining and blending includes the process of combining and blending about a 60% blend of about 50% loaded conductive carbon polymer with about a 40% blend of about 25% loaded conductive carbon polymer to form a thin conductive film with acceptable physicals, no pinholes and a resistance of less than about 10 ohms. Another embodiment of the process of combining and blending includes the process of combining and blending about a 66% blend of about 50% loaded conductive carbon polymer with about a 34% blend of about 25% loaded conductive carbon polymer to form a thin conductive film with acceptable physical characteristics, no pinholes and a resistance of less than about 5 ohms.

The present invention includes an optional process and associated apparatus for treating the surface of the film to enhance its surface energy, also referred to as dyne level, and thus improve its ability to bond to other materials. The process is preferably a corona treatment process known to those of skill in the art of fabricating non-metallic materials such as polymeric film materials. This optional process enhances the ability of the film of the present invention to bond to various other materials including, but not limited to, inks, coatings, metals, other non-metallic materials, semiconductor structures, dielectrics and electrolytes, as well as to form laminates, if that is of interest.

The films of the present invention are particularly suited for use as the conductive media for both anode and cathode electrodes in batteries. A known problem in the art was the difficulty of finding an electrode material of suitable thinness and resistance that does not react with active materials and that can be sealed to form a leak proof containment. Each of these problems is overcome by the films of the present invention. The films of the present invention are also suitable for use as the conductive media in electrodes in desalination and deionization systems. These and other advantages will become apparent upon reviewing the following detailed description, the accompanying figures and the appended claims.

### BRIEF DESCRIPTION OF THE DRAWINGS

FIG. 1 is a simplified representation of the primary components of the equipment used to combine the resins and then dry the combination in preparation for manufacturing the conductive film of the present invention.

FIG. 2 is a simplified representation of the primary components of the equipment used to manufacture the conductive film of the present invention in a cast extrusion process.

FIG. 3 is a simplified representation of additional film processing equipment used to complete the manufacture of the conductive film of the present invention in a cast extrusion process.

FIG. 4 is a depiction of a test fixture showing an embodiment of the conductive film of the present invention under testing for resistance through the film thickness.

FIGS. 5A and 5B are a representation of the conductive film of the present invention used as the conductive medium in an electrode in a stacked battery. FIG. 5A is a side view of the battery, and FIG. 5B is a top view of the battery.

FIGS. 6A-6C illustrate a method of measuring the Positive Temperature Coefficient Resistance of the conductive film of the present invention. FIGS. 6A and 6B show the instrumentation, and FIG. 6C shows representative results.

### DETAILED DESCRIPTION OF THE EMBODIMENTS OF THE INVENTION

A conductive film of the present invention is fabricated in a single layer or a plurality of layers. It includes a structural material blended with a conductive material into a form suitable for extrusion or blow molding as those processes are generally understood by those of ordinary skill in the art of polymer film fabrication. The structural material may be polyethylene, polypropylene and variants and blends thereof. The conductive material is carbon. The film may include other additives as desired. The structural material and additives are selected and processed to establish desired physical and electrical characteristics, and optional visual characteristics. The physical characteristics include, but are not limited to, a thickness of less than 12 mils, preferably less than five mils, and preferably about two mils. The film surface may include a certain dyne level that acts as a catalyst for the film to bond with various electrolytes. The physical characteristics may also include flexibility, sealability, tensile and tear strength and others of interest. The electrical characteristics include a resistance less than about 100 ohms, preferably less than about 50 ohms, and more preferably less than about 10 ohms. The physical and electrical characteristics of the films of the present invention make them particularly suited for use as the conductive media for cathode and anode electrodes in batteries or in desalination and deionization systems. Embodiments of the structural material and conductive material blends used to make the conductive film have been described hereinabove.

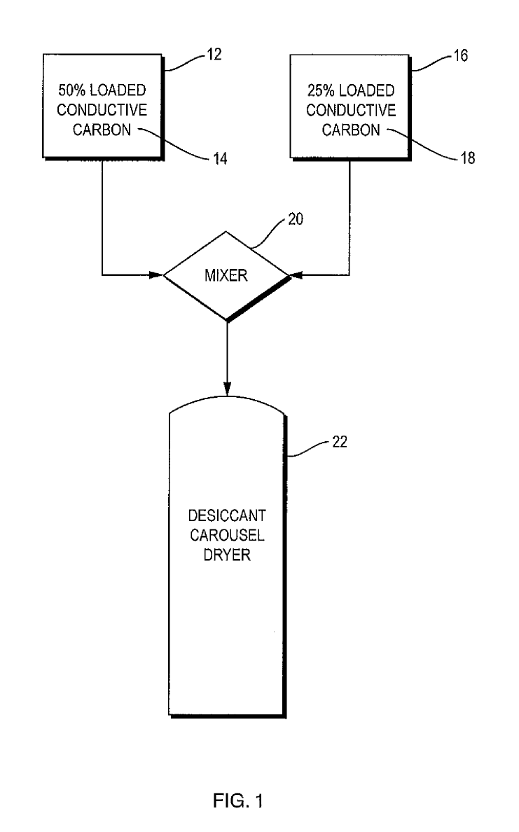

The process of making any of the blends described into the conductive film of the present invention involves steps in which a blended resin, such as in pellet form, is first created and then processed in a fabrication system 10 of the type represented as an example in FIGS. 1-3. As shown in FIG. 1, first container 12 includes first resin 14, which is a polymeric resin material including about 50% by weight of conductive carbon. Second container 16 includes second resin 18, which is a polymeric resin including about 25% by weight of a conductive carbon. The first resin 14 and the second resin 18 may be either or both of polyethylene and polypropylene or blends thereof and are available in pellet form. The first resin 14 and the second resin 18 may be combined in a selectable ratio. In one example embodiment of the conductive film of the present invention, the first resin 14 may be about 66% by weight of the combination and the second resin 18 may be about 34% by weight of the combination.

The two resins in pellet form are directed to mixer 20 and mixed together to form a conductive resin mix that is transferred to a desiccant carousel dryer 22, where the resin pellet mixture is dried to a selected moisture content. For the embodiment of the conductive film described herein, the conductive resin mixture is dried in the dryer 22 for about 12 hours at about 150° F. The mixer 20 and the dryer 22 are of the type known to those of ordinary skill in the art of manufacturing polymeric films. An example of a suitable mixer for initial formation of the conductive resin is a TrueBlend® model no. TB1800 series mixer available from Conair of Hartford, Conn. An example of a suitable desiccant carousel dryer for making the conductive resin pellets is a carousel dryer model no. W600 available from Conair of Hartford, Conn. The present invention is not limited to the use of that specific equipment.

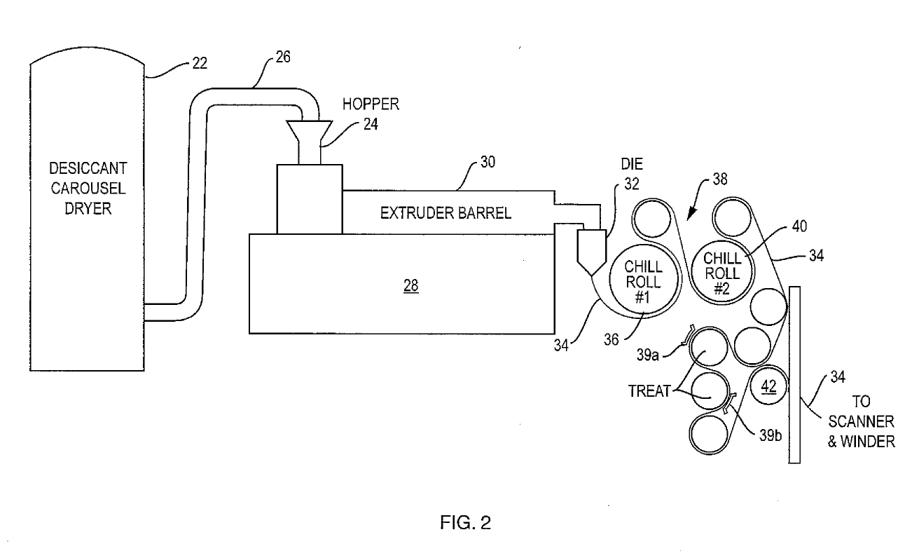

With reference to FIG. 2, dried conductive resin pellets are transferred from the desiccant carousel dryer 22 to hopper 24 via conduit 26. The hopper 24 is coupled to an extruder 28, including extruder barrel 30 having an entry end and an exit end and configured to convert the conductive film pellets into a fluidized solid. The conductive film extrudate exits the exit end of the extruder barrel 30 and enters die 32, which is arranged to shape the extrudate into a generally rectangular shape. While the present invention is described with respect to cast extrusion of the conductive film, those of skill in the art will recognize that a blown film die different from the die 32 may be used to enable a blown film fabrication process. As the first resin 14 and the second resin 18 include substantial amounts of carbon, it is desirable to maintain the extruder barrel 30 and the die 32 at relatively high temperatures, as extrusion temperature is important to establish an extrudate fluidity that eventually yields a desirable film quality. For the embodiment of the present invention described herein, the entry end of extruder barrel 30 is at a temperature of about 570° F. near the hopper 24 and is stepped down from that temperature with a temperature profile through the length of the extruder barrel 30 of about 540° F. to about 505° F. to about 450° F. and then to about 350° F. at the exit end near the die 32. The die 32 is at a temperature of about 420° F. The extruder 28 may be suitable for cast film or blown film fabrication, although the cast film process of the system 10 is described with respect to FIGS. 1-3. An example of a suitable extruder for fluidizing the conductive film pellets is a 4.5-inch single-layer line acquired from Sterling of Plainfield, N.J.

With continuing reference to FIG. 2, conductive film 34 exiting the die 32 is transferred to a first casting chiller roll 36 of multi-roller unit 38. The conductive film 34 may be in a range of thicknesses when first reaching the first roll 36, dependent upon the ultimate thickness desired. For example, the film 34 may be approximately, but is not limited to, about 2-15 mils thick as it moves to the first casting chiller roll 36. The film 34 is moved from the first chiller roll 36 to a second casting chiller roll 40. Rolls 36 and 40 may be of any selectable temperature, but the first roll 36 may be maintained at a temperature of about 150° F. and the second roll 40 may be maintained about at ambient temperature. This chilling of the film 34 acts to solidify it into a film-like material. From the second chiller roll 40, the film 34 is delivered to a first corona treatment roll 39A to treat one side of the film and may then be transferred to a second corona treatment roll 39B to treat the opposite side of the film. While not specifically shown in the drawing, generally speaking, corona discharge equipment includes a high-frequency power generator, a high-voltage transformer, a stationary electrode and a treater station, which may be one or more treater ground rolls, such as treatment rolls 39A and 39B. Electrical power is converted into higher frequency power which is then supplied to the treater station. The treater station applies this power through ceramic or metal electrodes over an air gap onto the film's surface. In this particular example of the present invention, first the one side and then the opposite side of the film 34. Such treatment should increase the dyne level at the surface of the film to be 10 dynes or greater than the particular electrolyte or material to which the film 34 is to be joined. In one example of the present invention, the film 34 may be treated with the corona treatment to achieve a dyne level of about 36 to 46, but not limited thereto. An example of a suitable corona treatment system is a Bare Roll Ceramic Electrode Corona Surface Treater acquired from Enercon Industries Corporation of Menomonee Falls, Wis. It is to be noted that the film 34 may treated in this manner on only one surface if that is of interest. From the second corona treatment roll 39B, the film is delivered to film stabilization unit 42.

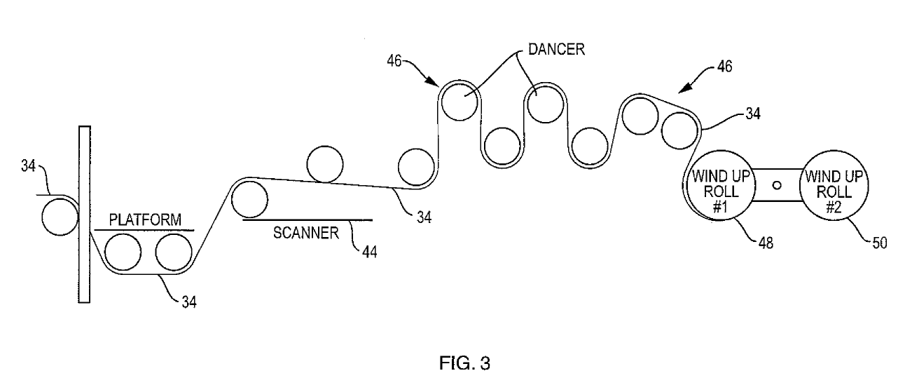

In the film-stabilization unit 42, the film 34 is maintained in tension after the chilling process. The film-stabilization unit 42 includes a plurality of rollers arranged and operated to minimize or eliminate film wrinkling and to generally maintain the uniform passage of the film 34 through the system 10. With reference to FIG. 3, the film 34 continues its passage along a series of rollers to a scanner 44 arranged to scan the film 34 passing by to aid in evaluating its thickness uniformity. The scanner 44 may be a density scanner such as the type available from Ohmart/Vega Corporation of Cincinnati, Ohio. Dependent upon the results of the scanning, the film 34 continues its passage to a series of film uniformity rollers 46 arranged to maintain sufficient tension of the film so that it remains substantially unwrinkled, but not so tense as to tear. Any of the film 34 deemed to be of unsatisfactory thickness uniformity based on the results of the evaluation provided by the scanner 44 may be discarded or otherwise re-processed. One or more of the film uniformity rollers 46 may be “dancing” rollers in that they have some flexibility of movement to ensure maintenance of film tension.

Finally, the conductive film 34 is wound onto either one of wind-up rolls 48 and 50 for storage or delivery to users, wherein the rolls 48 and 50 are arranged such that the film 34 winds on one of the two until full and then transfers to the other of the two rolls as the full roll pivots out of the process line.

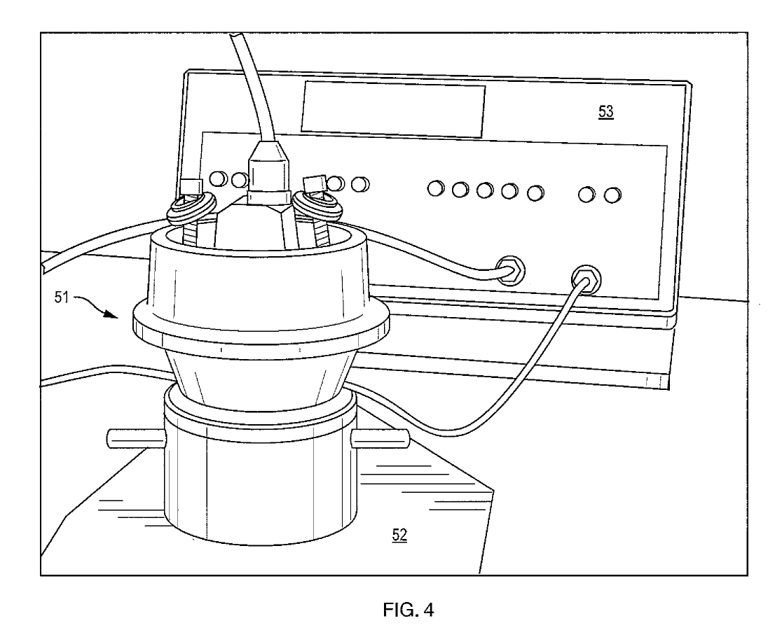

FIG. 4 depicts a test fixture 51 used to determine the resistance through the thickness of the embodiment of the conductive film 52 of the present invention in which the first resin 14 and the second resin 18 are combined such that the first resin 14 is about 66% by weight of the combination and the second resin 18 is about 34% by weight of the combination. The conductive film 52 of that composition and formed through use of the system 10 of FIGS. 1-3 was determined to have acceptable physical characteristics, a thickness of about 2 mils, no pinholes and a resistance of about 3 ohms. The resistance of the conductive film 52 was measured in the test fixture using a Dr. Kamphausen Milli-to-2 meter 53 available from Julie Associates of Billerica, Mass., with a concentric guardring electrode and a test electrode IAW standard DIN 53-482. The film test surface was about 20 cm² and the diameter of the film was about 4.95 cm. The resistance test was conducted in accordance with ASTM test D991.

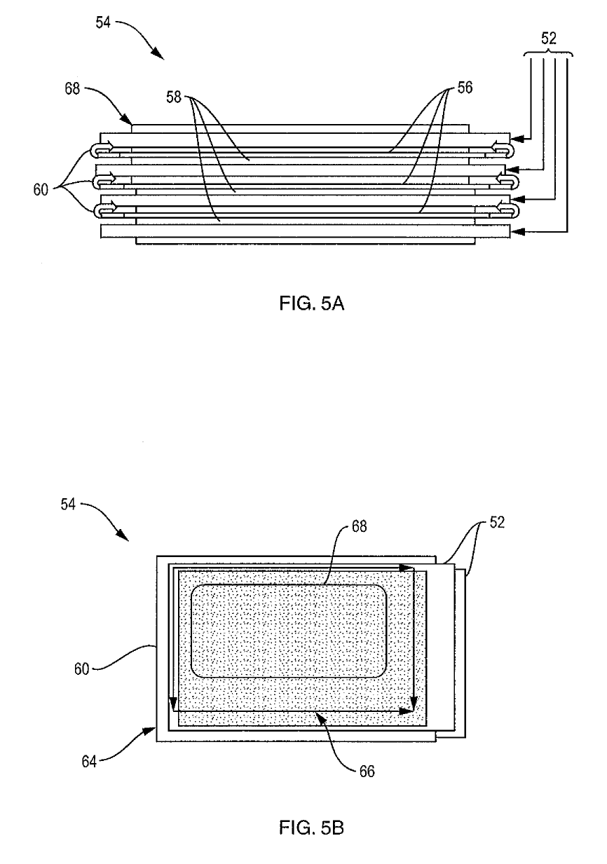

The present invention also encompasses products which make use of the conductive films of the present invention, as well as methods of making such products. For example, one application of the present invention is as the conductive medium of an electrode in a battery cell. FIGS. 5A and B illustrate a battery cell 54 incorporating the conductive film 52 of the present invention in a stack form. As illustrated in FIG. 5A, a method of manufacturing a battery cell 54 using a conductive film 52 of the present invention includes the steps of coating the conductive film 52 with a cathode material 56 on one side of the film 52, and coating the conductive film 52 on the other side with a suitable anode material 58. In one embodiment, the battery 54 is a lithium battery, and exemplary suitable cathode materials coated on the conductive film 52 include, but are not limited to, cobalt, nickel, and phosphate. Exemplary suitable anode materials coated on the conductive film 52 for use in a lithium battery include, but are not limited to, titanium dioxide, hard carbon, or graphite. The conductive film 52 of the present invention can also be used in other types of batteries, such as lead acid and nickel metal hydride batteries. In some methods of manufacturing batteries, such as example battery 54, it may be necessary to treat the conductive film 52 by coating it with a metal such as tin to prevent oxidation.

As can be seen in FIG. 5A, once the conductive film 52 is coated with the cathode material 56 and anode material 58, the film 52 is stacked on a separator 60 that is folded on the edges. Folding the separator 60 is done to increase the amount of separator material 60 in sealing area 64 and to add non-conductive material to the sealing area 64. This configuration also reduces the chance that any conductive areas would short. Suitable separator materials 60 include any plastic that can be heat sealed or welded to the conductive film 52 of the present invention. The separator 60 may have approximately the same material composition and melting temperature as the conductive film 52, and one suitable example is polyethylene. As shown in FIG. 5B, the separator material 60 at one side of the battery cell 54 is sealed, and the conductive film 52 may be extended on the other side of the battery cell 54 so that a cell-to-cell balancing circuit (not shown) can be added to that end of the conductive film 52. A second side of the battery cell 54 is left open as a vent opening 66 of a vent for filling the battery cell 54 with electrolyte. The top and bottom of the stack are covered by an end electrode 68 such as aluminum that conducts electricity from the conductive plastic film 52 to an electrical circuit (not shown) or other device to be powered. The battery cell 54 as shown in FIG. 5A is then packaged using a system that applies vacuum pressure or physical pressure to the end walls of the battery cell 54. The number of stacks in a battery cell 54 can be any number sufficient to provide voltages useful in manufacture, preferably from 3 to 300, more preferably from 10 to 100. After the battery cell 54 is packaged and sealed, it is enclosed in a suitable housing. Suitable housings are known to those skilled in the art.

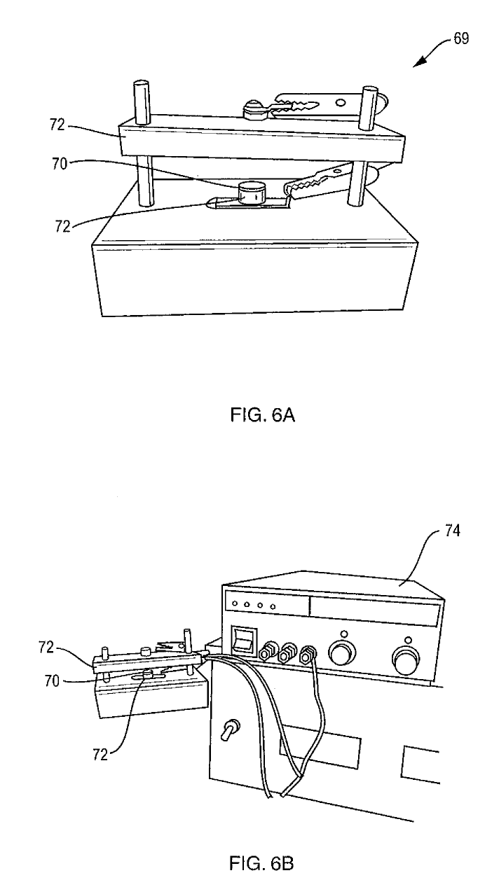

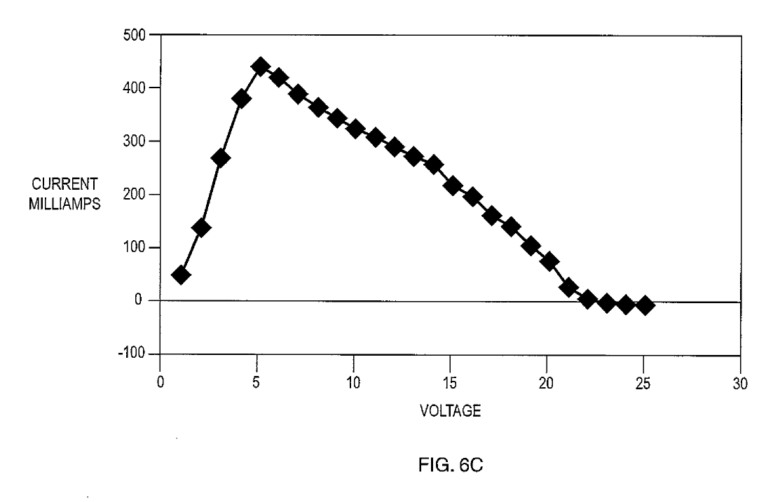

The conductive film 52 of the present invention has a unique property that allows it to be very effective and useful in batteries, and especially lithium batteries. This property is called Positive Temperature Coefficient Resistance (PTCR). Specifically, when the temperature of the conductive film 52 gets to a specific level, caused by an increase in current density, the film 52 starts to limit current flow. At a high enough level of power, the resistance of the film 52 goes very high, and protects the battery cell from short circuit. Currently, circuits must be protected from short circuits or surges by incorporating another device into the circuit, such as a PolySwitch, which is known to those of skill in the art. The PTCR properties of the conductive film 52 of the present invention can be seen in FIG. 6C. FIG. 6A shows an apparatus 69 for testing for PTCR. The test is run by punching out a round square cm film piece 70 of the conductive film and placing it between two copper electrodes 72. Using a power supply 74, the film piece 70 is subjected to an increasing voltage, allowing the current to run freely (see FIG. 6B). As can be seen in FIG. 6C, the current going through the film piece 70 starts to limit due to PTCR effects at about 5 volts. This voltage is where most advanced lithium battery cells will operate, and is an ideal voltage to protect the cell from short circuit. As voltage continues to increase, the film piece 70 becomes more resistant and, therefore, reduces current therethrough. This current reduction saves the battery from high voltage damage. It is to be understood that the conductive film composition may be modified to adjust its PTCR so that its resistance begins to increase at about a selectable voltage (potential) of interest, which may be higher or lower than the peak conductivity occurring at about 5 volts for the lithium battery example described herein. That is, the conductive film may be established with a PTCR at a selectable potential chosen to protect a battery of which it forms a part.

Another application of the present invention is as the conductive medium for an electrode for use in desalination and deionization. Present desalination processes require expensive equipment and materials and still fail to provide sufficient, affordable water to people who cannot obtain clean drinking water without great difficulty, if at all. The conductive film of the present invention can be used to meet this need as a desalinization and/or deionization device. In this application, the conductive film is laminated to a thin aluminum sheet. The aluminum sheet is then laminated to a dry process electrode (such as from Maxwell Technologies of San Diego, Calif.). The laminating can be carried out using any suitable method known in the art, including heat lamination or by conductive binder. Producing a multilayer electrode such as this requires little energy and no solvents, which is a dramatic improvement over traditional wet manufacturing processes. This type of electrode can be modified into low, medium, and high voltage designs and can reduce both energy use and costs associated with desalination processes, and similarly for deionization processes. An example desalination system employing electrodes using the conductive film of the present invention includes a holding tank with a charcoal filter and three desalination tanks. A voltage of approximately 0.5 volts would be applied to the conductive film configured electrodes in the first desalination tank to reduce the concentration of sodium chloride (NaCl) in the water from around 35,000 ppm to below 5000 ppm. The second and third tank would be arranged and operated similarly, but using higher voltages each time, resulting in a decrease in NaCl to less than 100 ppm after treatment in the third tank.

Electrodes made including the conductive film of the present invention have several advantages over traditional electrodes used in desalination. For example, electrodes using the conductive film of the present invention are more energy and cost efficient than traditional expensive coated metal electrodes, and have a longer lifespan because the polyolefin does not corrode, in contrast to traditional electrodes. A side benefit of using the conductive film in electrodes is based on selective site activation of the carbon, which allows for “mining” certain anions and cations from the source, thus acting as a deionization device.

It is to be understood that the specific films and methods described herein are but representations of options for making the conductive films of the present invention. This description is not intended to limit the principle concept of the present invention, and it is to be understood that various modifications may be made without departing from the spirit and scope of the invention. All equivalents are deemed to fall within the scope of this description of the invention.

What is claimed is:

1. A conductive film comprising:
a) a structural material; and
b) a conductive material blended with the structural material;
wherein the conductive film is less than about 12 mils thick and has a resistance of less than about 100 ohms.

2. The conductive film of claim 1, wherein one or both sides of the film has been surface treated to enhance its ability to bond to other materials.

3. The conductive film of claim 1, wherein the film is less than about 6 mils thick and has a resistance of less than about 50 ohms.

4. The conductive film of claim 3, wherein the film is less than about 2 mils thick and has a resistance of less than about 10 ohms.

5. The conductive film of claim 1, wherein the structural material and the conductive material are combined in a ratio selected to establish a Positive Temperature Coefficient Resistance (PTCR) of interest.

6. The conductive film of claim 4, wherein the structural material and the conductive material are combined in a ratio to establish a PTCR that produces a peak conductivity at about a particular selectable potential with an increasing resistance at voltages above that particular selectable potential, including for use with a power source having no current limit.

7. The conductive film of claim 1, wherein the film is single layer or multilayer.

8. The conductive film of claim 1, wherein the structural material is selected from the group consisting of polyethylene, polypropylene, or blends thereof.

9. The conductive film of claim 1, wherein the film includes about a 40% blend of about 50% loaded conductive carbon polymer with about a 60% blend of about 25% loaded conductive carbon polymer.

10. The conductive film of claim 1, wherein the film includes about a 50% blend of about 50% loaded conductive carbon polymer with about a 50% blend of about 25% loaded conductive carbon polymer.

11. The conductive film of claim 1, wherein the film includes about a 60% blend of about 50% loaded conductive carbon polymer with about a 40% blend of about 25% loaded conductive carbon polymer.

12. The conductive film of claim 1, wherein the film includes about a 66% blend of about 50% loaded conductive carbon polymer with about a 34% blend of about 25% loaded conductive carbon polymer.

13. A conductive film comprising:
a) a structural material;
b) a conductive material blended with the structural material; and
c) one side of the film is selectively coated by vapor deposition of one or more materials selected from the group consisting of metals, semiconductors, and dielectrics;
wherein the conductive film is less than about 6 mils thick and has a resistance of less than about 10 ohms.

14. The conductive film of claim 13, wherein one or both sides of the film has been surface treated to enhance its ability to bond to other materials.

15. The conductive film of claim 13, wherein both sides are selectively coated by vapor deposition of one or more materials selected from the group consisting of metals, semiconductors, and dielectrics.

16. The conductive film of claim 13, wherein the film is selectively coated with aluminum, copper, or tin by vacuum metallization.

17. The conductive film of claim 13, wherein the film is selectively coated with a permanent or removable non-metallic material.

18. A method for producing a conductive film comprising the steps of:
a) mixing together a first resin blend and a second resin blend to form a conductive resin mix, wherein the first resin blend includes a first amount of a conductive material loaded polymer and the second resin blend includes a second amount of a conductive material loaded polymer;
b) drying the conductive resin mix to a selected moisture content;
c) converting the conductive film resin into a fluidized solid; and
d) forming a film using cast film or blown film fabrication into one or more layers.

19. The method of claim 18, wherein the method further includes a step of surface treating one or both sides of the film to enhance its ability to bond to other materials.

20. The method of claim 18, wherein the step of converting the conductive film resin into a fluidized solid is carried out using an extruder barrel with a temperature profile of about 570° F. near the entry end and is stepped down through the length of the extruder barrel from about 540° F. to about 505° F. to about 450° F. and then to about 350° F. near the exit end.

21. The method of claim 20, wherein the fluidized solid moves from the exit end of the extruder barrel to a die at a temperature of about 420° F.

22. The method of claim 18, wherein the step of combining and blending a plurality of resins with different conductive carbon loaded polymers includes combining and blending about a 40% blend of about 50% loaded conductive carbon polymer with about a 60% blend of about 25% loaded conductive carbon polymer.

23. The method of claim 18, wherein the step of combining and blending a plurality of resins with different conductive carbon loaded polymers includes combining and blending about a 50% blend of about 50% loaded conductive carbon polymer with about a 50% blend of about 25% loaded conductive carbon polymer.

24. The method of claim 18, wherein the step of combining and blending a plurality of resins with different conductive carbon loaded polymers includes combining and blending about a 60% blend of about 50% loaded conductive carbon polymer with about a 40% blend of about 25% loaded conductive carbon polymer.

25. The method of claim 18, wherein the step of combining and blending a plurality of resins with different conductive carbon loaded polymers includes combining and blending about a 66% blend of about 50% loaded conductive carbon polymer with about a 34% blend of about 25% loaded conductive carbon polymer.
